(19) United States
(12) Patent Application Publication
(10) Pub. No.: US 2025/0352852 A1
(43) Pub. Date: Nov. 20, 2025

(54) METHOD, APPARATUS, AND SYSTEM FOR ANALYZING MOVING OBJECT

(71) Applicant: VC INC., Seoul (KR)

(72) Inventors: Byung Hee JUNG, Yongin-si (KR); Sunjin YOON, Seoul (KR); Hee Joon PARK, Gwangju-si (KR)

(21) Appl. No.: 18/725,395

(22) PCT Filed: Nov. 14, 2022
(86) PCT No.: PCT/KR2022/017891

§ 371 Date: Jan. 24, 2025

(30) Foreign Application Priority Data
Jan. 28, 2022 (KR) 10-2022-0013677

(51) Int. Cl. A63B 24/00; A63B 69/36; A63B 71/06; G01S 13/58

(52) U.S. Cl. CPC A63B 24/0021; A63B 69/3623; A63B 71/0622; G01S 13/58; A63B 2024/0028; A63B 2071/0627; A63B 2071/063; A63B 2220/13; A63B 2220/89; A63B 2225/50; A63B 2225/74

(57) ABSTRACT

Disclosed is a method of analyzing a moving object, the method including: measuring, by the distance sensor, a distance to an object located in front; determining whether the measured distance is within a predetermined range; when the measured distance is within a predetermined range, notifying a ready state; and obtaining, by a radar including a plurality of antennas, a result of a shot for the object.

### TECHNICAL FIELD

The present disclosure relates to a method, an apparatus, and a system for analyzing a moving object.

### BACKGROUND OF THE INVENTION

In various situations, it may be desirable to analyze the various flight characteristics of moving objects. One of the situations is in sports where moving objects are used, such as baseballs, golf balls, tennis balls, hockey pucks, cricket balls, and target shooting bullets.

Players and spectators of these sports are interested in the speeds, shot angles, paths, and landing locations of moving objects. However, analyzing a trajectory of a moving object may have problems in processing cost and difficulty in obtaining and analyzing data. In addition, players want to analyze their own motion having high relation to the moving object.

### DISCLOSURE

### Technical Problem

The present disclosure attempts to provide a method, an apparatus, and a system for analyzing a moving object, which guide an initial setting location of a measurement target.

The present disclosure also attempts to provide a method, an apparatus, and a system for analyzing a moving object, which are easily portable.

The present disclosure also attempts to provide a method, an apparatus, and a system for analyzing a moving object, which may reduce production costs.

### Technical Solution

In addition to the above technical problems, the exemplary embodiments of the present disclosure may be used to accomplish other objectives not specifically mentioned.

An exemplary embodiment of the present disclosure is a method of analyzing a moving object, the method including: measuring, by the distance sensor, a distance to an object located in front; determining whether the measured distance is within a predetermined range; when the measured distance is within a predetermined range, notifying a ready state; and obtaining, by a radar including a plurality of antennas, a result of a shot for the object.

The notifying of the ready state may include: indicating, by a display unit, that the object is at an appropriate distance; outputting, by a sound output unit, a voice indicating that the object is at the appropriate distance; and/or emitting, by a light output unit, light to indicate that the object is at the appropriate distance.

The notifying of the ready state may include: when the measured distance is within the predetermined range, transmitting a ready notification signal to an external device via a communication unit; and i) indicating, by a display unit of the external device, that the object is at the appropriate distance; ii) outputting, by a sound output unit of the external device, a voice indicating that the object is at the appropriate distance; and/or iii) emitting, by a light output unit of the external device, light to indicate that the object is at the appropriate distance.

The method may further include, when the measured distance is within the predetermined range, stopping the operation of the distance sensor or reducing the frequency of operation of the distance sensor.

The method may further include, when the measured distance is outside the predetermined range, notifying a direction and distance by which a location of the object needs to be calibrated.

The notifying of the direction and distance by which the location of the object needs to be calibrated may include: displaying, by the display unit, the direction and distance by which a location of the object needs to be calibrated; and/or outputting, by a sound output unit, a direction and distance by which a location of the object needs to be calibrated with a voice.

Another exemplary embodiment of the present disclosure provides an apparatus for analyzing a moving object, the apparatus including: a radar including a plurality of antennas; a distance sensor for measuring a distance to an object located in front; and a control unit for determining whether the measured distance is within a predetermined range, and outputting a ready state when the measured distance is within the predetermined range, and controlling the radar to obtain a shot result for the object.

The apparatus may further include: a display unit, in which the control unit outputs the ready state to indicate that the object is at an appropriate distance from the display unit, and a sound output unit, in which the control unit outputs the ready state such that the sound output unit outputs a voice indicating that the object is at an appropriate distance; and/or a light output unit, in which the control unit outputs the ready state such that the light output unit emits light to indicate that the object is at an appropriate distance.

The apparatus may further include a communication unit, in which the control unit transmits a ready notification signal to an external device via the communication unit when the measured distance is within the predetermined range.

The control unit may stop an operation of the distance sensor and/or reduce a frequency of operation when the measured distance is within the predetermined range.

When the measured distance is outside the predetermined range, the control unit may notify a direction and distance by which a location of the object needs to be calibrated.

In the notifying of the direction and distance by which the location of the object needs to be calibrated, the apparatus may further include a display unit, in which the control unit controls the display unit to display the direction and distance by which the location of the object needs to be calibrated; and/or a sound output unit, in which the control unit controls the sound output unit to output a voice notifying the direction and distance by which the location of the object needs to be calibrated.

Still another exemplary embodiment of the present disclosure provides a system for analyzing a moving object, the system including: a first apparatus including a communication unit, a radar including a plurality of antennas, and a distance sensor for measuring a distance to an object located in front; and a second apparatus including a communication unit, an output unit, and a control unit that outputs a ready state to the output unit when the measured distance is within a predetermined range, and notifies a direction and distance by which a location of the object needs to be calibrated when the measured distance is outside the predetermined range.

The first apparatus may transmit, via the communication unit, information about the measured distance to the second apparatus, and the control unit of the second apparatus may determine whether the measured distance is within the predetermined range by using the information about the measured distance.

The first apparatus may transmit a ready notification signal to the second apparatus via the communication unit when the measured distance is within the predetermined range, and the control unit of the second apparatus may output the ready state to the output unit in accordance with the ready notification signal.

The first apparatus may transmit a ball location calibration notification signal to the second apparatus via the communication unit when the measured distance is outside the predetermined range, and the control unit of the second apparatus may output the direction and distance by which a location of the object needs to be calibrated to the output unit in accordance with the ball location calibration notification signal.

The control unit of the second apparatus may output a control signal to the first apparatus via the communication unit to stop an operation of the distance sensor and/or reduce a frequency of the operation when the measured distance is within the predetermined range.

### Advantageous Effects

The effects of the method, apparatus, and system for analyzing the moving object according to the present disclosure are described below.

According to at least one of the exemplary embodiments of the present disclosure, it is advantageous that a user is capable of conveniently locating a measurement target at an initial location.

According to at least one of the exemplary embodiments of the present disclosure, it is advantageous to provide the user with more accurate information about the estimated driving distance.

According to at least one of the exemplary embodiments of the present disclosure, it is advantageous that the apparatus and the system for analyzing the moving object are conveniently portable for a user.

The additional scope of applicability of the present disclosure will become apparent from the following detailed description. However, it should be understood that the detailed description and specific exemplary embodiments, such as the exemplary embodiment of the present disclosure, are given by way of illustration only, since various changes and modifications within the scope of the present disclosure may be clearly understood by those skilled in the art.

### DESCRIPTION OF THE DRAWINGS

FIG. 1 is a conceptual diagram illustrating a method, an apparatus, and a system for analyzing a moving object according to an exemplary embodiment.

FIG. 2 is a block diagram illustrating the apparatus for analyzing the moving object according to the exemplary embodiment.

FIG. 3 is a conceptual view of the apparatus for analyzing the moving object according to the exemplary embodiment viewed from one direction.

FIG. 4 is a diagram illustrating dislocation locations of the apparatus for analyzing the moving object and the moving object according to the exemplary embodiment.

FIG. 5 is a block diagram illustrating a mobile communication device according to the exemplary embodiment.

FIG. 6 is a flow chart illustrating a method of analyzing a moving object according to an exemplary embodiment.

FIG. 7 is a flow chart illustrating a method of analyzing a moving object according to another exemplary embodiment.

FIG. 8 is a diagram illustrating an example of a screen indicating an calibration of a location of a moving object according to the method of analyzing the moving object according to the exemplary embodiment.

FIG. 9 is a diagram illustrating an example of a screen indicating a ready state of a moving object according to the method of analyzing the moving object according to the exemplary embodiment.

### DETAILED DESCRIPTION OF THE EMBODIMENTS

Hereinafter, an exemplary embodiment disclosed the present specification will be described in detail with reference to the accompanying drawings, and the same or similar constituent factor is denoted by the same reference numeral regardless of a reference numeral, and a repeated description thereof will be omitted. Suffixes, “module” and and/or “unit” for a component used for the description below are given or mixed in consideration of only easiness of the writing of the specification, and the suffix itself does not have a discriminated meaning or role. Further, in describing the exemplary embodiment disclosed in the present disclosure, when it is determined that detailed description relating to well-known functions or configurations may make the subject matter of the exemplary embodiment disclosed in the present disclosure unnecessarily ambiguous, the detailed description will be omitted. Further, the accompanying drawings are provided for helping to easily understand exemplary embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various components, but the components are not limited by the terms. The terms are used only to discriminate one component from another component.

It should be understood that when one constituent element referred to as being “coupled to” or “connected to” another constituent element, one constituent element may be directly coupled to or connected to the other constituent element, but intervening elements may also be present. In contrast, when one constituent element is “directly coupled to” or “directly connected to” another constituent element, it should be understood that there are no intervening element present.

In the present application, it will be appreciated that terms “including” and “having” are intended to designate the existence of characteristics, numbers, operations, operations, components, and components described in the specification or a combination thereof, and do not exclude a possibility of the existence or addition of one or more other characteristics, numbers, operations, operations, components, and components, or a combination thereof in advance.

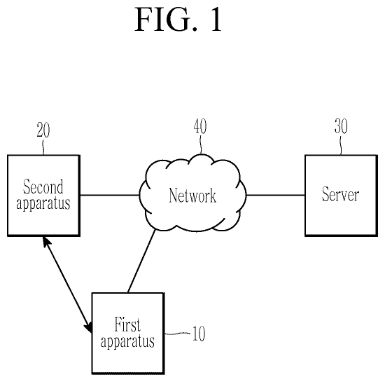

FIG. 1 is a conceptual diagram illustrating a method, an apparatus, and a system for analyzing a moving object according to an exemplary embodiment.

Referring to FIG. 1, a system for analyzing a moving object according to exemplary embodiments may include a moving object analysis apparatus (hereinafter referred to as a “first apparatus”) 10, a mobile communication device (hereinafter referred to as a “second apparatus”) 20, and a server 30. However, the scope of the present disclosure is not intended to be limited thereto, and the system for analyzing the moving object may include additional components beyond those illustrated in FIG. 1, and some components may be omitted.

The first apparatus 10 may use a radar sensor to emit transmitting waves to an object and detect reflected waves from the object. For example, the first apparatus 10 may emit transmitting waves to a golf ball and a golf club (for example, a club head) and detect reflected waves that are a mixture of reflected waves from the club and reflected waves from the golf ball. The first apparatus 10 may calculate, from the detected inputs, a swing speed (of the club or bat), a smash factor indicating an accuracy of the strike (of the club or bat), a speed of the moving object, a shot angle, a carry distance, a traveling trajectory, and the like as resultant information.

The second apparatus 20 may be in wired or wireless communication with the first apparatus 10. The second apparatus 20 may receive at least one of the detected input and the resultant information from the first apparatus 10. Based on the received data and information, the second apparatus 20 may calculate a swing speed (of the club or bat), a smash factor indicative of the accuracy of the strike (of the club or bat), a speed of the moving object, a shot angle, a carry distance, a travel trajectory, and the like.

In addition, the second apparatus 20 may receive inputs to adjust factors that affect the movement of the moving object from the user. Based on the user inputs and the data and information received from the first apparatus 10, the second apparatus 20 may calculate the speed, carry distance, travel trajectory, and the like of the moving object.

In addition, the second apparatus 20 may be wired or wirelessly connected to a wearable device, may receive user's input input to the wearable device, and may output processed data to the wearable device.

The server 30 may be a computing device that provides services to at least one of the first apparatus 10 and the second apparatus 20 over a network. That is, the server 30 may include any computing device, such as a personal computer, blade server, and mainframe, that may run server software to provide services to other devices or software.

The server 30 may receive various information from at least one of the first apparatus 10 and the second apparatus 20, and may provide a service for guiding trajectory information, swing information, and the like of the moving object when a request is made from the second apparatus 20.

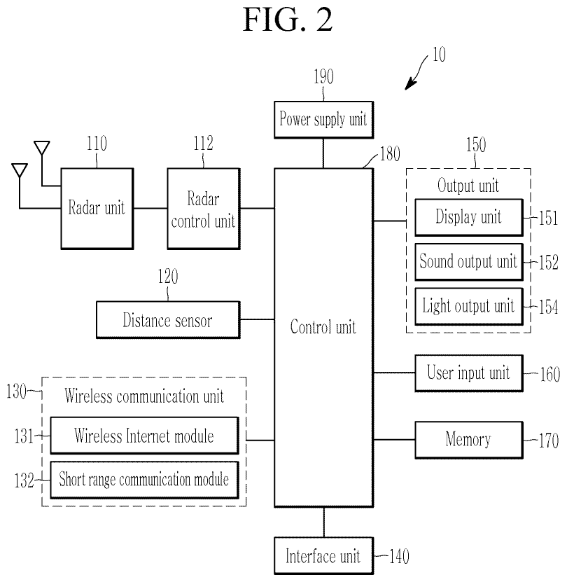

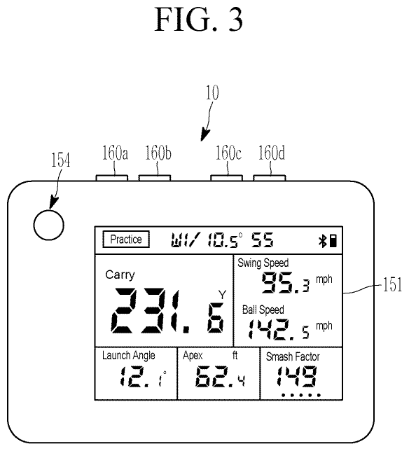

FIG. 2 is a block diagram illustrating the first apparatus according to the exemplary embodiment, and FIG. 3 is a conceptual view of the apparatus for analyzing the moving object according to the exemplary embodiment viewed from one direction.

Referring to FIG. 2, the first apparatus 10 may include a radar unit 110, a radar control unit 112, a distance sensor 120, a wireless communication unit 130, an interface unit 140, an output unit 150, a user input unit 160, a memory 170, a control unit 180, and a power supply unit 190. The components illustrated in FIG. 2 are not essential to implement the first apparatus 10, and the first apparatus 10 described in the present specification may have more or fewer components than those listed above.

The radar unit 110 includes a signal source and a plurality of antennas. The radar unit 110 may a Doppler radar. The plurality of antennas is spaced in a vertical direction, and when a signal emitted from the signal source is reflected from an object, the plurality of antennas receives the signal. The radar unit 110 may measure a distance between an object in front (described herein as a ball, but also including, without limitation, a golf club) and the radar unit 110 by using the signal received from the plurality of antennas.

The radar control unit 112 controls the operation of the radar unit 110. For example, the radar control unit 112 controls the radar unit 110 to track and measure the distance to the ball when the ball in front of the radar unit 110 moves (that is, the distance to the ball measured from the radar unit 110 changes).

The radar control unit 112 may calculate a speed of the ball, a spin rate of the ball, a shot angle, a carry distance, a traveling trajectory, and the like by using the distance information between the ball and the radar unit 110 measured by the radar unit 110. Further, the radar control unit 112 may calculate a swing speed of the club, a smash factor, and the like by using the distance information between the club and the radar unit 110 measured by the radar unit 110. Although the result values are described as being calculated by the radar control unit 112, the control unit 180 may also receive the distance information between the ball and the radar unit 110 measured by the radar unit 110 and the distance information between the measured club and the radar unit 110 from the radar control unit 112 and calculate the result values by using the received distance information.

The distance sensor 120 measures the distance to an object located in the direction that the radar unit 110 is facing. The distance sensor 120 may be implemented as a TOF sensor. The TOF sensor may include a light-emitting part and a light-receiving part. The light-emitting part of the TOF sensor may emit light toward an object. The object may be, for example, a golf ball located in the direction that the radar unit 110 is facing. The light (or signal) emitted from the light-emitting part of the TOF sensor may be reflected from some surface of the object and directed to the light-receiving unit of the TOF sensor. The object for reflection of the TOF sensor may have a surface that helps reflect the light (or signal). For example, the surface of the object may include a specific color (for example, white) and/or a specific pattern.

The TOF sensor may measure the distance between the TOF sensor and the object by the time taken for light to be emitted from the light-emitting part, reflected by the object, and returned to the light-receiving part. The TOF sensor may emit a signal at the light-emitting part, detect the signal at the light-receiving part, and measure the time of flight of the signal by the time interval between the emission of the signal and the detection of the signal. Since the signal emitted by the light-emitting part may affect the light-receiving part, a barrier (not shown) may be installed between the light-emitting part and the light-receiving part. The light-emitting part emits light modulated with a signal of a certain frequency f, and the light-receiving part may detect the light reflected back from the object. Herein, the signal may be modulated as a pulse wave or a continuous-wave (CW). As the signal (light) travels to and from the TOF sensor and the object, the phase of the signal changes, and the TOF sensor may calculate the distance between the TOF sensor and the object by using the phase change.

Next, the wireless communication unit 130 may include one or more modules that enable wireless communication between the first apparatus 10 and a wireless communication system, between the first apparatus 10 and other wirelessly communicable devices, or between the first apparatus 10 and an external server.

The wireless communication unit 130 may include a wireless Internet module 131, a short range communication module 132, and the like.

The wireless Internet module 131 refers to a module for wireless Internet access, and may be embedded in the first apparatus 10. The wireless Internet module 131 is configured to transmit and receive wireless signals in a communication network according to wireless Internet technologies. Examples of the wireless Internet technologies include wireless LAN (WLAN), wireless-fidelity (Wi-Fi), wireless fidelity (Wi-Fi) direct, digital living network alliance (DLNA), wireless broadband (WiBro), world interoperability for microwave access (WiMAX), high speed downlink packet access (HSDPA), high speed uplink packet access (HSUPA), long term evolution (LTE), long term evolution-advanced (LTE-A), new radio (NR), and the like, and the wireless Internet module 131 transmits and receives data according to at least one wireless Internet technology in the range including Internet technologies not listed above.

The short range communication module 132 is for short range communication and may support short range communication by using at least one of Bluetooth™, radio frequency identification (RFID), infrared data association (IrDA), ultra-wideband (UWB), ZigBee, near field communication (NFC), wireless-fidelity (Wi-Fi), Wi-Fi Direct, and wireless universal serial bus (Wireless USB) technologies. As such, the short range communication module 132 may support wireless communication between the first apparatus 10 and a wireless communication system, between the first apparatus 10 and the wirelessly communicable device 20 or the like, or between the first apparatus 10 and a network where the external server 30 is located, via wireless area networks. The short-range wireless communication network may be a short range wireless personal area network.

Here, the wirelessly communicable device may be a mobile terminal, for example, a smartphone, a tablet PC, or a notebook, capable of exchanging data with (or interoperable with) the first apparatus 10 according to the present disclosure. The short range communication module 132 may detect (or recognize) wirelessly communicable devices that are capable of communicating with the first apparatus 10, in the vicinity of the first apparatus 10. Further, the control unit 180 may transmit at least a portion of the data processed on the first apparatus 10 to the wirelessly communicable device via the short range communication module 132, when the detected wirelessly communicable device is a device authorized to communicate with the first apparatus 10 according to the exemplary embodiment. Thus, a user of the wirelessly communicable device may use the data processed on the first apparatus 10 through the wirelessly communicable device.

The interface unit 140 serves as a passage to various types of external devices that are connected to the first apparatus 10. The interface unit 140 may include at least one of an external charger port, a wired/wireless data port, and a memory card port. In response to the connection of an external device to the interface unit 140, the first apparatus 10 may perform appropriate controls associated with the connected external device.

The output unit 150 is for generating an output related to visual sensation, audible sensation, tactile sensation, or the like, and may include a display unit 151, a sound output unit 152, a light output unit 154, and the like.

The display unit 151 displays (outputs) the information processed in the first apparatus 10. For example, the display unit 151 may display execution screen information of an application program driven in the first apparatus 10 or user interface (UI) and graphic user interface (GUI) information according to the execution screen information. There may be two or more display units 151 depending on the implementation type of the first apparatus 10.

The display unit 151 may include at least one of a liquid crystal display (LCD), a thin film transistor-liquid crystal display (TFT LCD), an organic light-emitting diode (OLED), and an e-ink display.

The sound output unit 152 may output audio data stored in the memory 170 as sound, and may be implemented in the form of a loud speaker outputting various alarm sounds or play sound of multimedia.

The light output unit 154 outputs a signal for notifying the occurrence of an event by using light from a light source of the first apparatus 10. An example of the event occurring in the first apparatus 10 may be a ball location calibration notification event, a ready notification event, a shot result notification event, and the like.

The signal output by the light output unit 154 is implemented by the first apparatus 10 emitting a single color or multiple colors of light from the front or back side. The signal output may be terminated according to the detection of the user acknowledgement of the event by the first apparatus 10.

Next, the user input unit 160 is for receiving information from a user, and when the information is input via the user input unit 160, the control unit 180 may control the operation of the first apparatus 10 in response to the input information. As such, the user input unit 160 may include a mechanical input means (or, a mechanical key, for example, a button located on the front, rear, or lateral side of the first apparatus 10, a bezel or crown of the first apparatus 10, a dome switch, a jog wheel, or a jog switch) and a tactile input means. In one example, the tactile input means may include a virtual key, soft key, or visual key displayed on a touchscreen through software processing, or a touch key disposed on a part other than the touchscreen. In the meantime, the virtual key or visual key may be displayed on the touchscreen in various forms, for example, as a graphic, text, icon, video, or a combination thereof.

In addition, the memory 170 stores data that supports various functions of the first apparatus 10 (for example, the data includes information about the set location of the moving object, swing speed, smash factor indicative of the accuracy of the strike, speed of the moving object, shot angle, carry distance, travel trajectory, and the like, but is not limited thereto). The memory 170 may store firmware, application programs, data, and instructions for the operation of the first apparatus 10 that run on the first apparatus 10. At least some of the application programs may be present on the first apparatus 10 from the factory for basic functionality of the first apparatus 10. Further, at least some of the application programs may be downloaded from an external server through wireless communication. In the meantime, the application program may be stored in the memory 170 and is installed in the first apparatus 10 to be driven so that the operation (or function) of the first apparatus 10 is performed by the control unit 180.

In addition to the operation related to the application program, the control unit 180 may generally control the general operation of the first apparatus 10. The control unit 180 may process the signal, the data, the information, and the like input or output through the foregoing components or drive the application program stored in the memory 170 to provide the appropriate information or function to the user or process the appropriate information or function.

Further, the control unit 180 may control at least some of the components described with reference to FIG. 2 in order to drive the application program stored in the memory 170. Further, the control unit 180 may operate at least two of the components included in the first apparatus 10 in combination with each other to drive the application program.

The power supply unit 190, under the control of the control unit 180, receives power from an external power source and an internal power source and provides power to each of the components included in the first apparatus 10. The power supply unit 190 includes a rechargeable battery, and the battery may be an embedded battery or a replaceable battery.

At least some of each of the components may operate in cooperation with each other to implement the operation of the first apparatus 10, the control, or the control method of the first apparatus according to various exemplary embodiments which will be described below. Further, the operation, the control, or the control method of the first apparatus 10 may be implemented on the first apparatus 10 for driving at least one application program stored in the memory 170.

Referring to FIG. 3, the first apparatus 10 has a bar-shaped body. However, the present disclosure is not limited thereto, but may be applied to various structures, such as a folder type, a flip type, a slide type, a swing type, or a swivel type, in which two or more bodies are relative movably coupled. This may be related to a particular type of first apparatus 10, but the description of a particular type of first apparatus 10 may be generally applicable to other types of first apparatus 10.

Herein, the body may be understood as a concept in which the first apparatus 10 is considered as at least one aggregate.

The first apparatus 10 includes a case (for example, frame, housing, or cover) that forms its exterior. Various electronic components are disposed in the interior space of the case.

The display unit 151 may be disposed on the front side of the body of the first apparatus 10 to output information. In addition, the first apparatus 10 may be equipped with the light output unit 154, first to fourth manipulating units 160a to 160d, the sound output unit (not shown), a distance sensor (not shown), and the like.

The display unit 151, the distance sensor (not shown), the light output unit 154, and the sound output unit (not shown) may be disposed on the front side of the body of the first apparatus 10, and the first to fourth manipulating units 160a to 160d may be disposed on the lateral side of the terminal body.

However, these configurations are not limited to these dislocations. The configurations may be excluded, replaced, or arranged on other sides as desired.

The display unit 151 displays (outputs) the information processed in the first apparatus 10. For example, the display unit 151 may display execution screen information of an application program driven in the first apparatus 10 or user interface (UI) and graphic user interface (GUI) information according to the execution screen information.

The display unit 151 may include at least one of a liquid crystal display (LCD), a thin film transistor-liquid crystal display (TFT LCD), an organic light-emitting diode (OLED), a flexible display, a 3D display, and an e-ink display.

Further, there may be two or more display units 151 depending on the implementation type of the first apparatus 10. In this case, the first apparatus 10 may have a plurality of display units spaced apart or integrally arranged on one surface, or may be arranged on different surfaces, respectively.

The display unit 151 may include a touch sensor for detecting a touch on the display unit 151 so that control instructions may be input by touch. By using this, when a touch is made on the display unit 151, the touch sensor detects the touch, and the control unit 180 may be configured to generate a control instruction corresponding to the touch based on the detected touch. The content input by the touch manner may be letters or numbers, directions in various modes, or designable menu items.

On the other hand, the touch sensor may be disposed on the display unit 151 in the form of a film having a touch pattern, or may be integrally formed with the display unit 151. For example, the touch sensor may be disposed on a substrate of the display unit 151, or may be internal to the display unit 151.

Similarly, the display unit 151 may form a touch screen with a touch sensor, and in this case, the touch screen may function as the user input unit (160 in FIG. 2).

The sound output unit 152 may be implemented in the form of a loud speaker that outputs various alarm sounds or play sounds of multimedia.

The light output unit 154 is configured to output light to indicate the occurrence of an event when the event occurs. An example of the event may be a ball location calibration notification event, a ready notification event, a shot result notification event, and the like. When a user acknowledgment of the event is detected, the control unit 180 may control the light output unit 154 to terminate the output of light.

The first to fourth manipulating units 160a to 160d may also be collectively referred to as the manipulating portion as an example of the user input unit 120 that is manipulated to receive instructions to control the operation of the first apparatus 10. The first to fourth manipulating units 160a to 160d may be adopted in any manner that allows the user to manipulate the manipulating unit in a tactile manner, such as touching, pushing, or scrolling. Further, the first to fourth manipulating units 160a to 160d may also be adopted in a manner that allows the user to manipulate the manipulating unit without tactile sensation, such as proximity touch or hovering touch.

In the present drawings, the first to fourth manipulating units 160a to 160d are illustrated as being push keys (mechanical keys), but the present disclosure is not limited thereto. For example, the first manipulating unit 160a may be a touch key, or may be formed of a combination of a touch key and a push key.

The contents input by the first to fourth manipulating units 160a to 160d may be variously set. For example, the first manipulating unit 160a may receive instructions, such as menu, home key, maycel, and search, and the second manipulating unit 160b may receive instructions, such as adjusting the volume of sound output from the sound output unit 152, or switching to the touch recognition mode of the display unit 151.

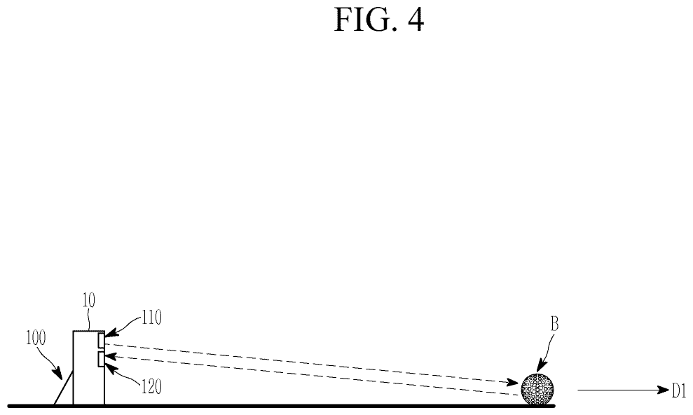

On the other hand, a rear side of the body of the first apparatus 10 may be provided with a support part (not shown) for supporting the first apparatus 10. Such the support part may support the first apparatus 10 to be in a state for measuring a moving object. In this regard, this will be described with reference to FIG. 4.

FIG. 4 is a diagram illustrating dislocation locations of the apparatus for analyzing the moving object and the moving object according to the exemplary embodiment.

As illustrated in FIG. 4, the support part 100 may be located on the rear side of the first apparatus 10. The support part 100 supports the first apparatus 10 such that the radar unit 110 and the distance sensor 120 of the first apparatus 10 face a moving object B. The moving object B is located in a direction D1 in which the radar unit 110 and the distance sensor 120 of the first apparatus 10 are facing.

In this case, the accuracy of the motion characteristics of the moving object B measured by the radar unit 110 varies depending on the distance between the first apparatus 10 and the moving object B. Therefore, the moving object B needs to be spaced from the first apparatus 10 within a predetermined range.

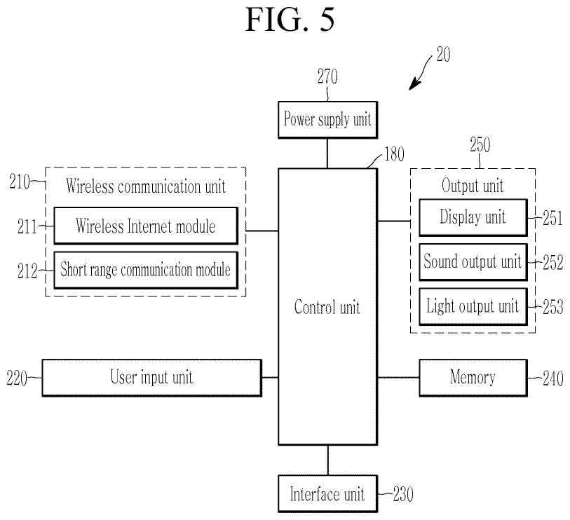

The first apparatus 10 has been described above. Hereinafter, the second apparatus 20 will be described with reference to FIG. 5.

FIG. 5 is a block diagram illustrating a mobile communication device according to the exemplary embodiment.

Referring to FIG. 5, the second apparatus 20 includes a wireless communication unit 210, a user input unit 220, an interface unit 230, a memory 240, an output unit 250, a control unit 260, and a power supply unit 270. The components illustrated in FIG. 3 are not essential to implement the second apparatus 20, and the second apparatus 20 described in the present specification may have more or fewer components than those listed above.

The descriptions of a wireless communication unit 210, a user input unit 220, an interface unit 230, a display unit 251, a sound output unit 252, and a power supply unit 270 are identical and similar to the previously described descriptions of the wireless communication unit 110, the user input unit 160, the interface unit 130, the display unit 151, the sound output unit 152, and the power supply unit 170, and are therefore omitted.

The vibration output unit 253 generates various tactile effects that may be felt by the user. The intensity and pattern of vibrations generated by the vibration output unit 253 may be controlled by user selection or settings in the control unit 180. For example, the vibration output unit 253 may synthesize and output different vibrations or sequentially output different vibrations.

Additionally, the memory 240 may store data that supports various functions of the second apparatus 20 (for example, the data includes information about swing speed, a smash factor indicating the accuracy of a strike, the speed of a moving object, a shot angle, a carry distance received from the first apparatus 10, and information about the traveling trajectory, and the like, and course map information about tee boxes, fairways, hazards, bunkers, roughs, greens, holes, and the like of a predetermined golf course, but is not limited thereto). The memory 240 may store firmware and application programs driven in the second apparatus 20, and data and instructions for operating the second apparatus 20. At least some of the application programs may be present on the second apparatus 20 from the factory for basic functionality of the second apparatus 20. Further, at least some of the application programs may be downloaded from an external server through wireless communication. In the meantime, the application program may be stored in the memory 240 and is installed in the second apparatus 20 to be driven so that the operation (or function) of the second apparatus 20 is performed by the control unit 260.

In addition to the operation related to the application program, the control unit 260 may generally control the general operation of the second apparatus 20. The control unit 260 may process the signal, the data, the information, and the like input or output through the foregoing components or drive the application program stored in the memory 240 to provide the appropriate information or function to the user or process the appropriate information or function.

Further, the control unit 260 may control at least some of the components described with reference to FIG. 5 in order to drive the application program stored in the memory 240. Further, the control unit 260 may operate at least two of the components included in the second apparatus 20 in combination with each other to drive the application program.

At least some of each of the components may operate in cooperation with each other to implement the operation of the second apparatus 20, the control, or the control method of the second apparatus according to various exemplary embodiments which will be described below. Further, the operation, the control, or the control method of the second apparatus 20 may be implemented on the second apparatus 20 for driving at least one application program stored in the memory 240.

The second apparatus 20 may be applied to various structures, such as a watch type, a clip type, a glasses type, or a slide type in which two or more bodies are combined to be relatively movable, a swing type, and a swivel type. The present disclosure may be related to the specific type of second apparatus 20, but the description about the specific type of the second apparatus 20 may be generally applied to another type of second apparatus 20.

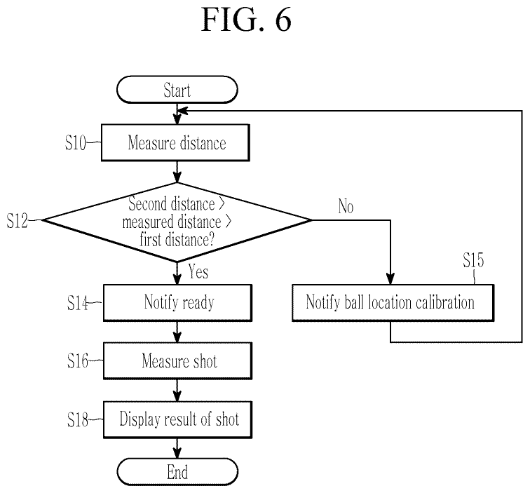

Hereinafter, a method of analyzing a moving object will be described with reference to FIGS. 6 to 9.

FIG. 6 is a flowchart illustrating a method of analyzing a moving object according to an exemplary embodiment.

Referring to FIG. 6, the distance sensor 120 of the first apparatus 10 measures a distance from a moving object B to be measured (S10). For example, the ToF sensor of the first apparatus 10 may measure the distance between the TOF sensor and the moving object B by the time taken for light to be emitted from the light-emitting part and reflected by the moving object B and returned to the light-receiving part.

The control unit 180 of the first apparatus 10 determines whether the measured distance is within a predetermined range (S12).

When the measured distance is within the predetermined range, the control unit 180 notifies the readiness via the output unit 150 (S14). For example, the control unit 180 displays a screen on the display unit 151 indicating that the moving object B to be measured is at an appropriate distance from the first apparatus 10. In another example, the control unit 180 outputs a voice indicating that the moving object B to be measured is at an appropriate distance from the first apparatus 10 via the sound output unit 152. In another example, the control unit 180 activates the light output unit 154 with a color, light emission pattern, or the like indicating that the moving object B to be measured is at an appropriate distance from the first apparatus 10.

When the measured distance is outside the predetermined range, the control unit 180 notifies a ball location calibration via the output unit 150 (S14). For example, the control unit 180 displays a screen on the display unit 151 indicating a distance by which the moving object B to be measured needs to be further away from the first apparatus 10 or a distance by which the moving object B needs to approach the first apparatus 10. In another example, the control unit 180 outputs a voice via the sound output unit 152 indicating a distance by which the moving object B to be measured needs to be further away from the first apparatus 10 or a distance by which the moving object B needs to approach the first apparatus 10. That is, the control unit 180 may output the direction and distance by which the location of the moving object B needs to be calibrated via the output unit 150.

Next, when the measured distance is within a predetermined range, the radar unit 110 measures a shot (S16). The radar unit 110 detects a signal reflected from the moving object B, and the radar control unit 112 may calculate the speed of the ball, the rotation speed of the ball, the shot angle, the swing speed of the club, the smash factor, and the like from the detected signal, and calculate a carry distance, a driving distance, a travel trajectory, and the like from the calculated ones.

On the other hand, when the measurement distance remains within the predetermined range (that is, in the ready state), the light-emitting part of the ToF sensor may stop emitting light or reduce the frequency of emission to prevent possible interference between the ToF sensor and the radar unit 110.

The control unit 180 outputs a result of the shot via the output unit 150 (S18). The result of the shot may include information measured directly from the measured target (ball and/or club) and/or information (for example, ball speed, ball rotation speed, shot angle, club swing speed, and smash factor) primarily calculated from the measured information. Further, the result of the shot may further include information secondarily calculated by using the foregoing information (for example, carry distance, driving distance, travel trajectory, and apex height).

For example, the control unit 180 may display the carry distance, ball speed, club swing speed, shot angle, smash factor, and apex height on the display unit 151, as illustrated in FIG. 3. In another example, the control unit 180 may select some of the results of the shot and output a voice for the selected results via the sound output unit 152.

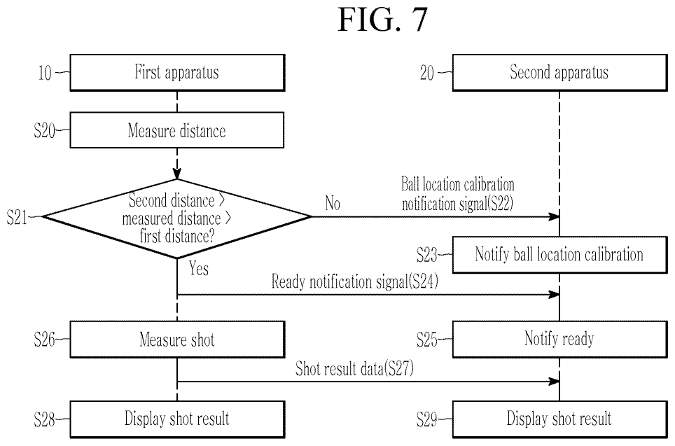

Next, a method of analyzing a moving object will be described according to another exemplary embodiment with reference to FIGS. 7 to 9.

FIG. 7 is a flow chart illustrating a method of analyzing a moving object according to another exemplary embodiment.

Referring to FIG. 7, the first apparatus 10, which is wired or wirelessly connected to the second apparatus 20, measures a distance to the moving object B to be measured (S20).

The control unit 180 of the first apparatus 10 determines whether the measured distance is within a predetermined range (S21).

When the measured distance is outside the predetermined range, the control unit 180 of the first apparatus 10 transmits a ball location calibration notification signal to the second apparatus 20 via the wireless communication unit 130 and/or the interface unit 140 (S22).

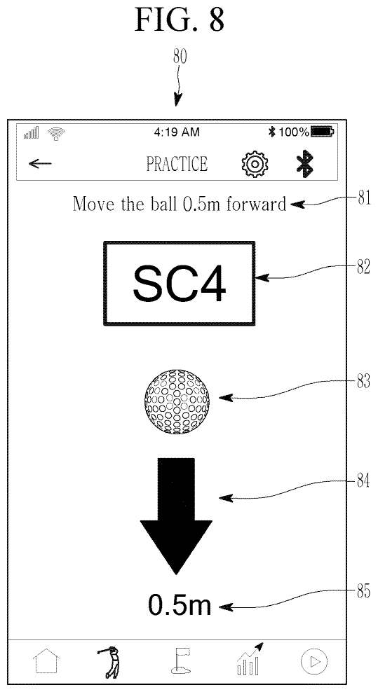

When the second apparatus 20 receives the ball location calibration notification signal, the control unit 260 of the second apparatus 20 notifies the ball location calibration via the output unit 250 (S23). For example, the control unit 260 displays a screen on the display unit 251 indicating a distance by which the moving object B to be measured needs to be further away from the first apparatus 10 or a distance by which the moving object B needs to approach the first apparatus 10. In another example, the control unit 260 outputs a voice via the sound output unit 252 indicating a distance by which the moving object B to be measured needs to be further away from the first apparatus 10 or a distance by which the moving object B needs to approach the first apparatus 10. In other words, the control unit 260 may output the direction and distance by which the location of the moving object B needs to be calibrated via the output unit 250. This will be described with reference to FIG. 8.

FIG. 8 is a diagram illustrating an example of a screen indicating an calibration of a location of a moving object according to the method of analyzing the moving object according to the exemplary embodiment.

As illustrated in FIG. 8, the second apparatus 20 may display a screen 80 on the display unit 251 indicating the ball location calibration. Within the screen 80, a guide text 81 indicating a direction and distance by which the location of the mobile object B needs to be calibrated, objects 82 and 83 corresponding to the first apparatus 10 and the moving object B, an indicator 84 indicating a direction by which the location of the moving object B needs to be calibrated, and an indicator 85 indicating a distance by which the location of the moving object B needs to be calibrated may be displayed

When the measured distance is within the predetermined range, the control unit 180 of the first apparatus 10 transmits a ready notification signal to the second apparatus 20 via the wireless communication unit 130 and/or the interface unit 140 (S24).

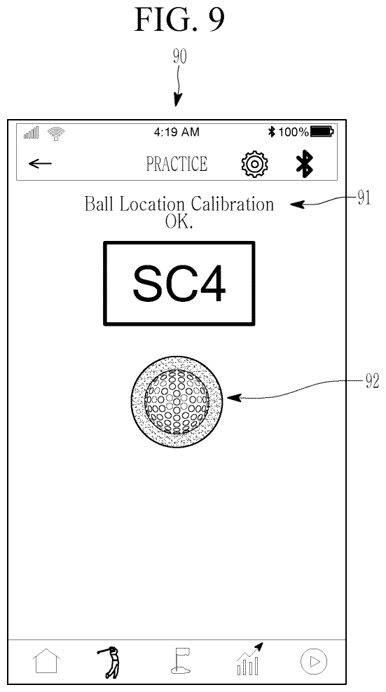

The control unit 260 of the second apparatus 20 notifies readiness via the output unit 250 (S25). For example, the control unit 260 displays a screen on the display unit 251 indicating that the moving object B to be measured is at an appropriate distance from the first apparatus 10. In another example, the control unit 260 outputs a voice via the sound output unit 252 to indicate that the moving object B to be measured is at an appropriate distance from the first apparatus 10. In another example, the control unit 260 activates the light output unit 253 with a color, light emission pattern, or the like that indicates that the moving object B to be measured is at an appropriate distance from the first apparatus 10. This will be described with reference to FIG. 9.

FIG. 9 is a diagram illustrating an example of a screen indicating a ready state of a moving object according to the method of analyzing the moving object according to the exemplary embodiment.

As illustrated in FIG. 9, the second apparatus 20 may display a screen 90 on the display unit 251 indicating a ball-ready state. Within the screen 90, a guide text 91 indicating that the moving object B is in a ready state, and an object 92 corresponding to the moving object B with a visual effect indicative of the ready state added may be displayed.

Next, the radar unit 110 of the first apparatus 10 measures a shot (S26). The first apparatus 10 then transmits a result of the shot to the second apparatus 20 (S27).

The control unit 180 of the first apparatus 10 outputs the result of the shot via the output unit 150 (S28). Similarly, the control unit 260 of the second apparatus 20 outputs the result of the shot via the output unit 250 (S29).

In FIG. 7, the control unit 180 of the first apparatus 10 was described as determining whether the measured distance is within the predetermined range, but the first apparatus 10 may transmit information about the measured distance to the second apparatus 20. Then, the control unit 260 of the second apparatus 20 may notify the ball location calibration via the output unit 250 when the measured distance is outside the predetermined range, and notify the readiness via the output unit 250 when the measured distance is within the predetermined range by using the information about the measured distance received from the first apparatus 10. The control unit 260 of the second apparatus 20 may transmit a control signal to the first apparatus 10 to stop the operation of the distance sensor 120, or to reduce the frequency of operation, when the measured distance is within the predetermined range.

Traditional moving object analysis apparatuses are unable to provide guidance on whether the moving object to be measured is in the right location to be measured, resulting in inaccurate measurement results.

According to the present disclosure, by guiding the initial set location of the object to be measured, it is possible to provide accurate measurement results for moving objects.

Furthermore, according to the present disclosure, the method, the apparatus, and the system for analyzing the moving object have the advantage of being able to provide information to a user quickly and are convenient for the user to carry.

The apparatuses according to various exemplary embodiments disclosed herein may be in various forms. The electronic device may include, for example, a portable communication device (for example, a smartphone), a computer device, a portable multimedia device, a portable medical device, a camera, a wearable device, or a consumer electronics device. The electronic devices according to the exemplary embodiments of the present disclosure are not limited to the foregoing devices.

The various exemplary embodiments of the present document and the terms used therein are not intended to limit the technical features described in this document to specific exemplary embodiments, and it should be understood to include various modifications, equivalents, or substitutions of the corresponding exemplary embodiment. In connection with the description of the drawings, like reference numerals may be used for similar or related components. The singular form of the noun corresponding to the item may include one or more of the item, unless the relevant context clearly dictates otherwise. In the present document, each of the terms, such as “A or B”, “at least one of A and B”, “at least one of A or B”, “A, B, or C”, “at least one of A, B, and C”, and “at least one of A, B, or C”, may include all possible combinations of items listed together in the corresponding one of the phrases. Terms, such as “first”, “second”, or “first” or “second” may simply be used to distinguish the corresponding constituent element from other corresponding constituent elements, and do not limit the corresponding constituent elements in another aspect (for example, importance or order). When it is referred that one (for example, a first) constituent element is “coupled” or “connected” to another constituent element (for example, a second) with or without the terms “functionally” or communicatively”, it means that the one constituent element may be connected to the another constituent element directly (for example, by wire), wirelessly, or through a third constituent element.

The terms “module” used in the present disclosure may include a unit implemented in hardware, software, or firmware, and are for example, interchangeable with terms, such as logic, logical block, component, or circuit. The module may be an integrally formed part or a minimum unit or a part of the part that performs one or more functions. For example, according to the exemplary embodiment, the module may be implemented in the form of an application-specific integrated circuit (ASIC).

Various exemplary embodiments of the present document may be implemented as software (for example, a program) including one or more instructions stored in a storage medium (for example, an internal memory or an external memory) readable by a machine (for example, an electronic device). For example, a processor of the machine (for example, an electronic device) may call at least one instructions among one or more stored instructions from the storage medium and execute the called instruction. This makes it possible for the device to be operated to perform at least one function in accordance with the called at least one instruction. The one or more instructions may include a code generated by a compiler or a code executable by an interpreter. The machine-readable storage medium may be provided in the form of a non-transitory storage medium. Herein, the “non-transitory” only means that the storage medium is a tangible device and does not include a signal (for example, electromagnetic wave), and this terms does not discriminate the case where data is semi-permanently stored in the storage medium and the case where data is temporarily stored.

According to the exemplary embodiment, the method according to various exemplary embodiments disclosed in the present document may be included in a computer program product and provided. The computer program product may be traded between sellers and buyers as commodities. The computer program product may be distributed in the form of a machine-readable storage medium (for example, a compact disc read only memory (CD-ROM), or may be directly and on-line distributed (for example, downloaded or uploaded) through two user devices (for example, smart phones) through an application store (for example, a Google's play store). In the case of the on-line distribution, at least some of the computer program products may be at least temporarily stored or temporarily generate in a machine-readable storage medium, such as a memory, of a server of a manufacturing company, a server of an application store, or a relay server.

According to various exemplary embodiments, each (for example, the module or the program) of the foregoing components may include single or plural objects. According to various exemplary embodiments, among the corresponding components, one or more components or operations may be omitted or one or more other components or operations may be added. Alternatively or additionally, the plurality of components (for example, a module or a program) may be implemented into one component

In this case, the combined component may perform one or more functions of each of the plurality of components identically or similarly to those performed by the corresponding component among the plurality of components prior to the integration. According to various exemplary embodiments, operations performed by a module, program, or other constituent elements may be executed sequentially, in parallel, repeatedly, or heuristically, or one or more of the operations may be executed in a different order or omitted, or one or more other operations may be added.

What is claimed is:

1. A method of analyzing a moving object, the method comprising:
measuring, by a distance sensor, a distance to an object located in front;
determining whether the measured distance is within a predetermined range;
notifying a ready state based on the measured distance is within a predetermined range; and
obtaining, by a radar including a plurality of antennas, a result of a shot for the object.

2. The method of claim 1, wherein:
the notifying of the ready state includes:
indicating, by a display unit, that the object is at an appropriate distance;
outputting, by a sound output unit, a voice indicating that the object is at the appropriate distance; and/or
emitting, by a light output unit, light to indicate that the object is at the appropriate distance.

3. The method of claim 1, wherein:
the notifying of the ready state includes:
transmitting a ready notification signal to an external device via a communication unit based on the measured distance is within the predetermined range; and
i) indicating, by a display unit of the external device, that the object is at the appropriate distance;
ii) outputting, by a sound output unit of the external device, a voice indicating that the object is at the appropriate distance; and/or
iii) emitting, by a light output unit of the external device, light to indicate that the object is at the appropriate distance.

4. The method of claim 1, further comprising:
stopping the operation of the distance sensor or reducing the frequency of operation of the distance sensor based on the measured distance is within the predetermined range.

5. The method of claim 1, further comprising:
notifying a direction and distance by which a location of the object needs to be calibrated based on the measured distance is outside the predetermined range.

6. The method of claim 5, wherein:
the notifying of the direction and distance by which the location of the object needs to be calibrated includes:
displaying, by the display unit, the direction and distance by which the location of the object needs to be calibrated; and/or
outputting, by a sound output unit, a direction and distance by which a location of the object needs to be calibrated with a voice.

7. An apparatus for analyzing a moving object, the apparatus comprising:
a radar including a plurality of antennas;
a distance sensor for measuring a distance to an object located in front; and
a control unit for determining whether the measured distance is within a predetermined range, and outputting a ready state based on the measured distance is within the predetermined range, and controlling the radar to obtain a shot result for the object.

8. The apparatus of claim 7, further comprising:
a display unit, wherein the control unit outputs the ready state to indicate that the object is at an appropriate distance from the display unit; and
a sound output unit, wherein the control unit outputs the ready state such that the sound output unit outputs a voice indicating that the object is at an appropriate distance; and/or
a light output unit, wherein the control unit outputs the ready state such that the light output unit emits light to indicate that the object is at an appropriate distance.

9. The apparatus of claim 7, further comprising:
a communication unit,
wherein the control unit transmits a ready notification signal to an external device via the communication unit when the measured distance is within the predetermined range.

10. The apparatus of claim 7, wherein:
the control unit stops an operation of the distance sensor and/or reduces a frequency of operation when the measured distance is within the predetermined range.

11. The apparatus of claim 7, wherein:
when the measured distance is outside the predetermined range, the control unit notifies a direction and distance by which a location of the object needs to be calibrated.

12. The apparatus of claim 11, further comprising:
in the notifying of the direction and distance by which the location of the object needs to be calibrated,
a display unit, wherein the control unit controls the display unit to display the direction and distance by which the location of the object needs to be calibrated; and/or
a sound output unit, wherein the control unit controls the sound output unit to output a voice notifying the direction and distance by which the location of the object needs to be calibrated.

13. A system for analyzing a moving object, the system comprising:
a first apparatus including a communication unit, a radar including a plurality of antennas, and a distance sensor for measuring a distance to an object located in front; and
a second apparatus including a communication unit, an output unit, and a control unit that outputs a ready state to the output unit when the measured distance is within a predetermined range, and notifies a direction and distance by which a location of the object needs to be calibrated when the measured distance is outside the predetermined range.

14. The system of claim 13, wherein:
the first apparatus transmits, via the communication unit, information about the measured distance to the second apparatus, and
the control unit of the second apparatus determines whether the measured distance is within the predetermined range by using the information about the measured distance.

15. The system of claim 13, wherein:
the first apparatus transmits a ready notification signal to the second apparatus via the communication unit when the measured distance is within the predetermined range, and
the control unit of the second apparatus outputs the ready state to the output unit in accordance with the ready notification signal.

16. The system of claim 13, wherein:
the first apparatus transmits a ball location calibration notification signal to the second apparatus via the communication unit when the measured distance is outside the predetermined range, and
the control unit of the second apparatus outputs the direction and distance by which a location of the object needs to be calibrated to the output unit in accordance with the ball location calibration notification signal.

17. The system of claim 13, wherein:
the control unit of the second apparatus outputs a control signal to the first apparatus via the communication unit to stop an operation of the distance sensor and/or reduce a frequency of the operation when the measured distance is within the predetermined range.
